(19) United States
(12) Patent Application Publication
(10) Pub. No.: US 2002/0030374 A1
(43) Pub. Date: Mar. 14, 2002

(54) Overhead parcel rack and HVAC duct

(76) Inventor: Herman Myburgh, Lascassas, TN (US)

Correspondence Address: HERMAN MYBURGH, 6995 CRADDOCK LANE, LASCASSAS, TN, 37085, US

(21) Appl. No.: 09/854,530

(22) Filed: May 15, 2001

Related U.S. Application Data
(60) Provisional application No. 60/205,475, filed on May 19, 2000.

(51) Int. Cl. B60R 7/08

(52) U.S. Cl. 296/37.7

(57) ABSTRACT

Overhead parcel rack and HVAC duct for public transportation vehicles such as buses and trains. Modular overhead parcel rack includes inboard and outboard vertical and bottom horizontal surfaces formed from composite material panels. Modular HVAC duct includes bottom horizontal and inboard vertical surfaces with attachment of overhead parcel rack to HVAC duct vertical surface. Longitudinally extending rail member attaches to inboard vertical surfaces of modular overhead parcel rack sections and is suspended from vehicle ceiling by means of formed hanger brackets. Modular sections of parcel rack and modular sections of duct are joined together by notched and formed unequal-length longitudinal strips.

### CROSS REFERENCE TO RELATED APPLICATIONS

Provisional Application No. 60/205,475, May 15, 2000

### BACKGROUND OF THE INVENTION

The present invention relates to overhead parcel racks and air conditioning ducts that can be installed on the inside of mass transportation vehicles of different manufacture and design. Traditionally overhead parcel rack and HVAC duct systems designed to be installed in mass transportation vehicles involved complex structural members, all or most of which required total redesign or major change to facilitate the adaptation and installation into vehicles of different manufacture, model or design. These systems involve numerous inconveniences as related to cost and complexity to manufacture, weight, ease of packaging and shipping, adaptation to vehicles of different design and manufacture that are overcome by the present invention.

U.S. Pat. No. 2,250,619, issued to Dwight E. Austin on Jul. 29, 1941 is unlike the present invention in that it describes an invention with the object of combining in a single assembly a package rack and an air duct for the distribution of conditioned air throughout the passenger compartment. Unlike the present invention, the Austin invention is constructed as an integral part of the body sidewall serving in a measure to stiffen the body of the vehicle. The Austin invention also incorporates a multitude of internal legs and braces riveted together in diagonal configuration designed to resist racking strains and transmit these loads into the vehicle body sidewalls. The vehicle body sidewalls in the Austin invention are also in turn stiffened by the package rack assembly itself.

U.S. Pat. No. 2,251,050 issued to Andrew T. Hagerty on Jul. 29, 1941 is unlike the present invention in that the Hagerty invention describes a baggage rack primarily consisting of and supported by several brackets spaced at suitable intervals and attached into the side posts or reinforcements in the frame of the vehicle. Rack bottom sections and specifically designed light boxes are attached between the brackets in the Hagerty invention.

U.S. Pat. No. 3,355,210 issued to Alan R. Cripe on Nov. 28, 1967 is unlike the present invention in that the Cripe invention describes an invention consisting of a plurality of angular mounts, perforated sheets and closure members designed with a plurality of functions and a primary objective of exhausting smoke and contaminants from the inside of the vehicle.

U.S. Pat. No. 3,577,903 issued to Walter S. Eggert, Jr. on May 11, 1971 is unlike the present invention in that the Eggert invention describes a support strut to support the overhead passenger grab rail and air duct inside a vehicle.

U.S. Pat. No. 5,113,322 issued to Liudas K. Mikalonis on May 12, 1992 is unlike the present invention in that the Mikalonis invention describes an interior lighting system using commercially available optical sheet material with incandescent lamps as a substitute for fluorescent tubes as previously described in U.S. Pat. No. 4,574,336 (Mikalonis) and U.S. Pat. No. 4,387,415 issued to Domas.

U.S. Pat. No. 5,441,326 issued to Liudas K. Mikalonis, on Aug. 15, 1995 is unlike the present invention in that the Mikalonis invention describes a combined air conditioning duct, luggage compartment and lighting fixture for mass transit vehicles consisting of unitary pultruded construction glass fibers. Unlike the present invention, the primary object of this invention by Mikalonis is to provide a luggage rack as a retrofit to or OEM installation with direct compatibility with previous U.S. Pat. No. 4,387,415 issued to Domas and U.S. Pat. No. 4,574,336 issued to Mikalonis.

U.S. Pat. No. 5,518,448 issued to Lino Madoglio and Benedetto Rossini, on May 21, 1996 is unlike the present invention in that it describes a curvilinear cross-sectional shaped, elastometric inner tube housed within an outer tube with air outlet apertures facing towards the inside of the vehicle. Unlike the present invention, the primary object of this invention is to provide even air distribution by means of an inner and outer duct design.

None of the inventions as described above, taken either singularly or in combination, is seen to describe the present invention as claimed.

### BRIEF SUMMARY OF THE INVENTION

This invention is directed to overhead parcel rack and HVAC duct systems installed on the inside of mass transportation vehicles. The object of the present invention is to overcome the above drawbacks by virtue of features of which reside in the fact that it comprises:

a heating, ventilation, and air conditioning (HVAC) duct is defined between the horizontal and vertical surface of the invention and the ceiling and sidewall in the cove area of a mass transportation vehicle, and

a formed overhead parcel rack having horizontal and vertical surfaces is attached along the vertical or horizontal surface to the vertical surface of above mentioned HVAC duct or attached directly to the inside along a surface above the side windows of the mass transportation vehicle, and

extruded longitudinal members are attached along the top of inboard vertical surface of above mentioned overhead parcel rack providing attachment of individual overhead parcel rack modules, a grab rail for passengers, rigid front lip to the overhead parcel rack system as well as attachment surface for ceiling mounted hanger brackets, and

hanger brackets of formed, rectangular in section longitudinal shape, are attached to the above longitudinal members through the inboard vertical surface of the overhead parcel rack and to the vehicle ceiling/roof structure through the hanger horizontal surface, and

contoured hanger covers installed over the above mentioned hangers are attached at the bottom by being sandwiched between hanger vertical surface and overhead parcel rack vertical surface where it is attached to the extruded longitudinal member. Upper attachment of hanger cover is accomplished by sandwiching upper horizontal surface between hanger upper horizontal surface and vehicle ceiling/roof at attachment of hanger bracket.

According to other features of the invention:

air outlet slots, registers or openings, and reading lights, speakers and/or small television monitors are provided on the lower horizontal surface of the HVAC duct for passenger comfort, and

air outlet slots or openings and lights are provided on the inboard vertical surface of the HVAC duct, and

formed endcaps effectively terminate and close the forward ends, rear ends and midship interrupted ends of the HVAC duct, the overhead parcel rack or both.

According to another feature of the invention, a secondary floor insert installed and suspended above the horizontal bottom surface of the overhead parcel rack by spacer blocks, provides a cavity for recessed or flush mounted reading lights mounted onto and through the bottom surface of said horizontal bottom surface of overhead parcel rack.

According to yet additional features of the invention, fabric, cloth, carpet, or vinyl material is laminated to the exposed surfaces of the HVAC duct and/or overhead parcel rack.

### BRIEF DESCRIPTION OF SEVERAL VIEWS OF THE DRAWINGS

FIG. 1 is an environmental perspective view of a combination overhead parcel rack and HVAC duct according to the present invention.

FIG. 2 is an environmental perspective view of an overhead parcel rack according to the present invention.

FIG. 3 is an exploded perspective view of an overhead parcel rack according to the present invention.

FIG. 4 is an enlarged perspective view of a divider strip.

FIG. 5 is an enlarged perspective view of a longitudinal rail member.

FIG. 6 is an enlarged sectional view of part of the present invention.

FIG. 7 is an environmental perspective view of an HVAC duct according to the present invention.

FIG. 8 is a rear exploded view of an HVAC duct according to the present invention.

FIG. 9 is a top perspective view of a combination overhead parcel rack and HVAC duct.

FIG. 10 is a perspective view of formed composite panel bends according to the present invention.

FIG. 11 is an exploded perspective view of composite panel.

### DETAILED DESCRIPTION OF THE INVENTION

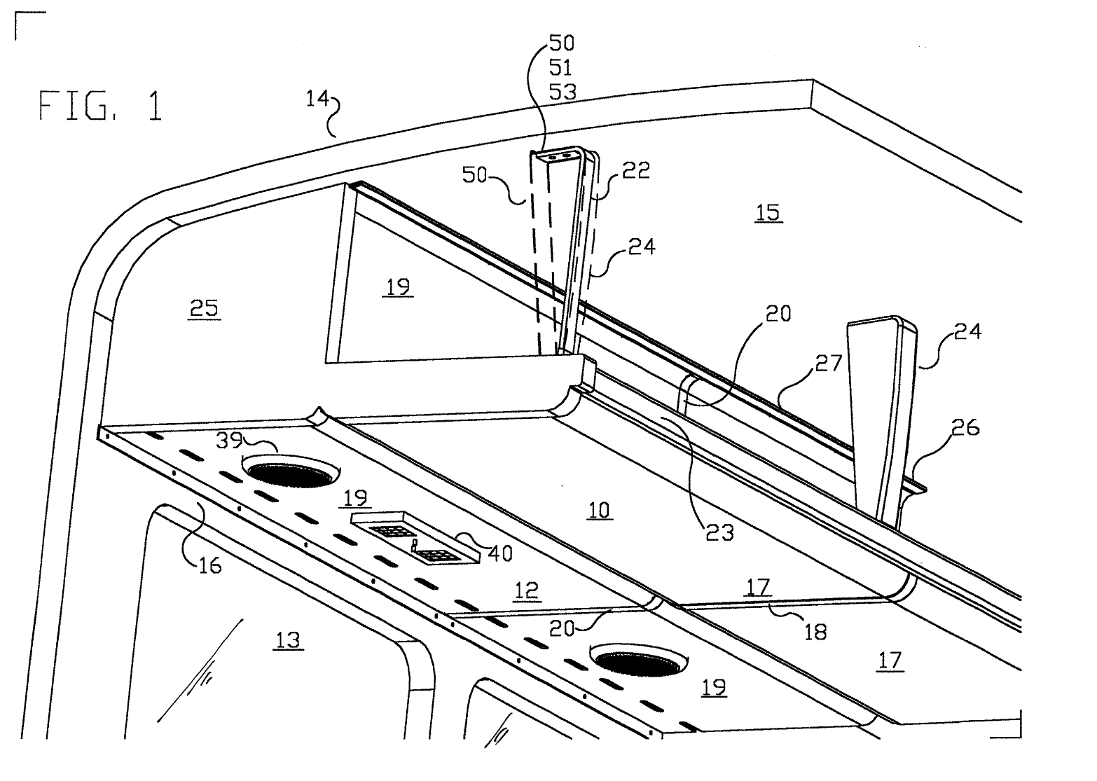

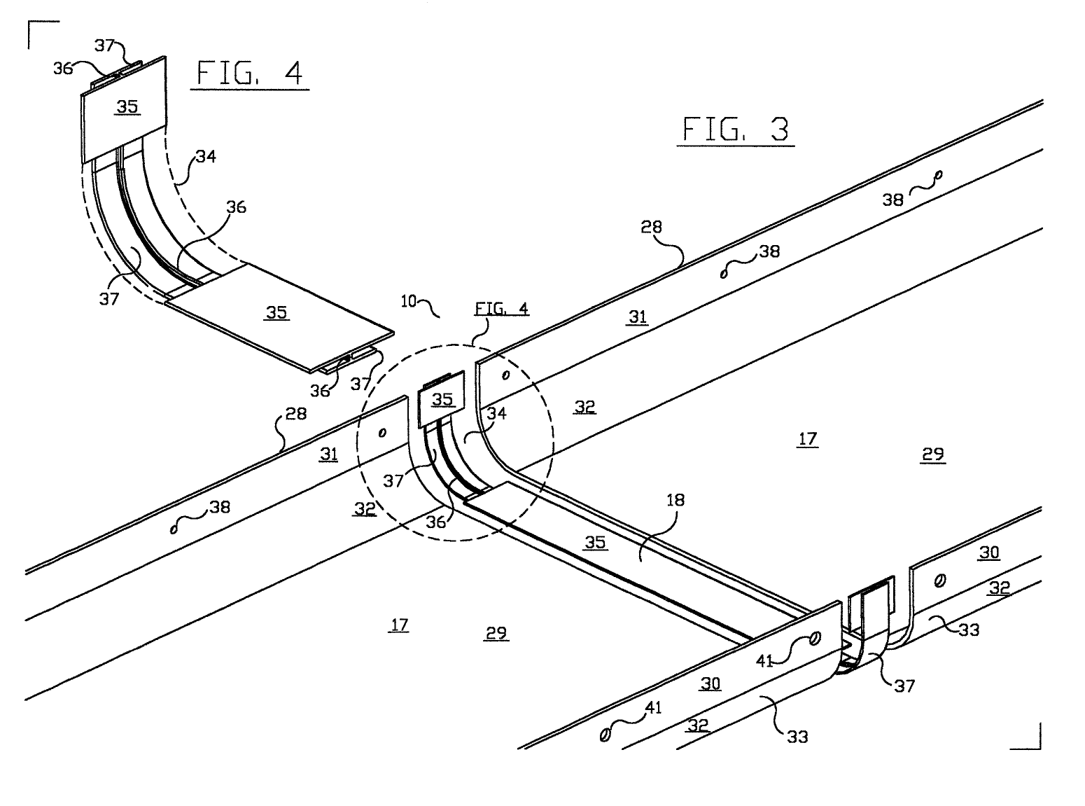

Referring to FIGS. 1 through 6, an overhead parcel rack indicated generally as 10 and an HVAC duct indicated generally as 12 are provided and generally installed longitudinally in the cove area above side windows 13 of a mass transportation vehicle 14 having a ceiling 15 and sidewall 16 above side windows 13. Modular longitudinal sections of overhead parcel rack 17 are connected end to end by means of longitudinally extruded divider strips 18. In a likewise manner, modular longitudinal sections of HVAC duct 19 are endwise connected to one another by longitudinally extruded divider strips 20. Vertically extended formed hanger brackets 22 are conveniently spaced and attached at their lower ends to longitudinally extending rail extrusion 23 after thermoformed or injection molded hanger covers 24 are installed over hanger brackets 22. Thermoformed or injected molded endcaps 25 covers overhead parcel rack 10 and HVAC duct 12 at forwardmost, rearmost and longitudinally in between interruption and termination locations of overhead parcel rack 10 and HVAC duct 12.

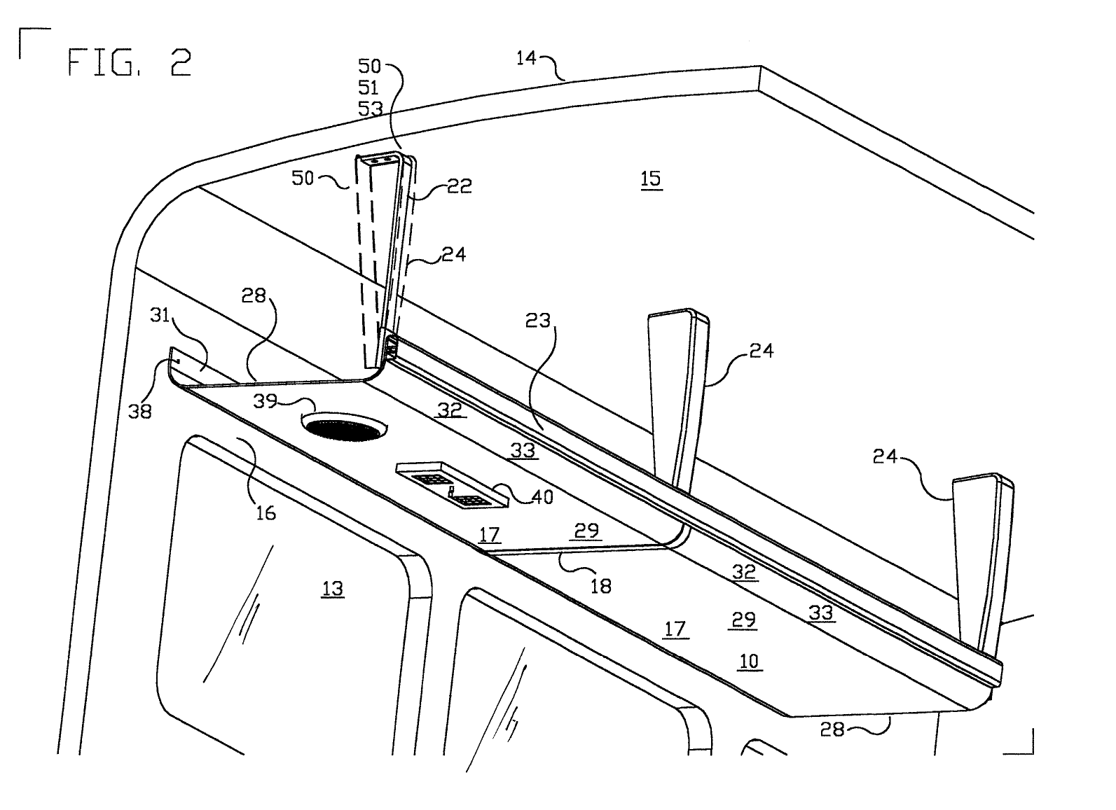

Uniform in cross-sectional shape, longitudinally extending edge trim 26 is provided along upper and/or lower HVAC mounting flanges 27. In one embodiment of the invention as shown in FIGS. 2 through 6, composite panel 28 is formed to create a horizontal bottom surface 29, an inboard vertical surface 30 and an outboard vertical surface 31. Bending of composite panel 28 is performed ensuring bend radius 32 to be minimally exceeding radius at which yield strength of composite material 28 outer skin 33 will be exceeded and thereby causing outer skin 33 fracture.

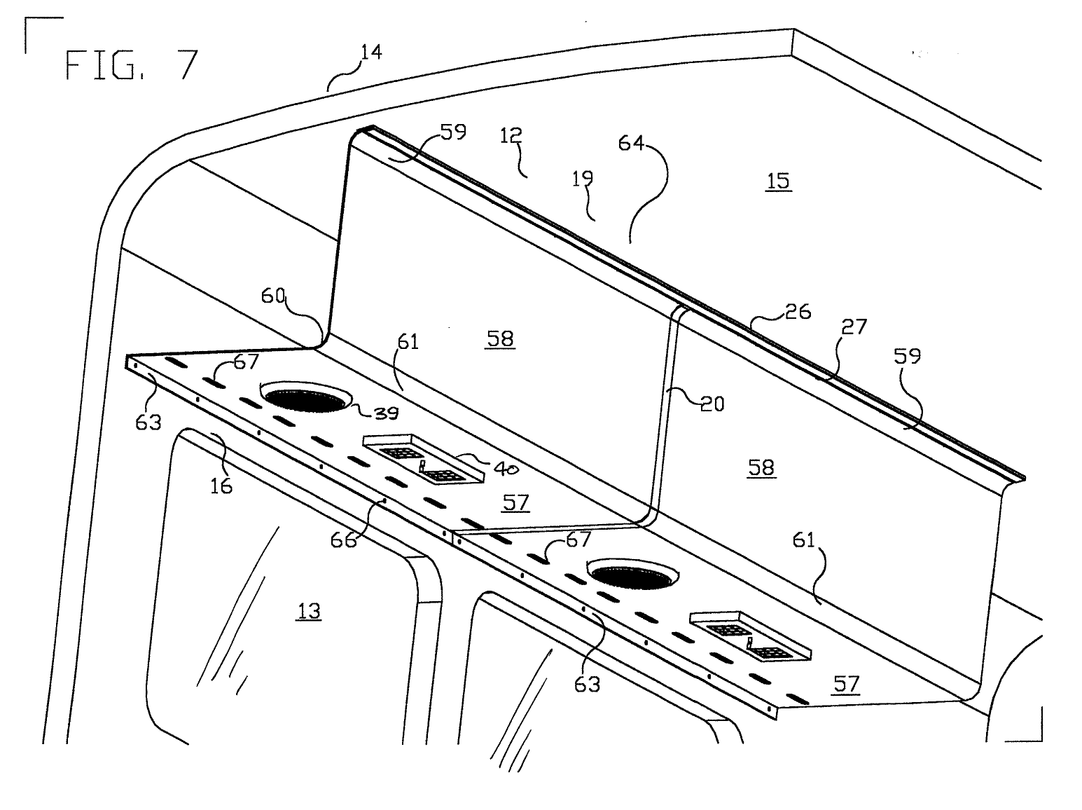

Modular sections of overhead parcel rack 17 are connected to longitudinally adjacent overhead parcel rack 17 section by means of uniform in cross-section longitudinally extruded plastic dividers 18 resembling unequal in length “H” shape. Dividers 28 are notched 34 allowing dividers 18 to easily conform to formed shape and bend radius 30 of adjoining modular sections of overhead parcel rack 17. Notching 34 of dividers 18 is accomplished by removing a portion of divider 18 inside leg 35 approximately equal in length to arc length of modular overhead parcel rack section 17 inside bend radius 32 leaving part of connection short leg 36 of overhead parcel rack divider 18 and all of outer short leg 37 of overhead parcel rack divider 18 in notched area 34 thereby facilitating the ease of shaping overhead parcel rack divider 18 to conform with bend radius, arc and angle in overhead parcel rack sections 17 during installation. Overhead parcel rack divider 18 is preferably of unequal length “H” cross-sectional shape, further easing end to end assembly and may also include holes 38 on outboard vertical surface 31 facilitating the attachment of overhead parcel rack section 17 onto vehicle sidewall 16 or modular section of HVAC duct 19 (FIG. 7). Bottom surface 29 of overhead parcel rack 17 also facilitates the convenience of speaker 39, reading lights 40, and other item installation. Overhead parcel rack section 17 includes mounting holes 41 on inboard vertical surface 30 facilitating the attachment of longitudinal rail member 23 onto outer surface of inboard vertical surface 30.

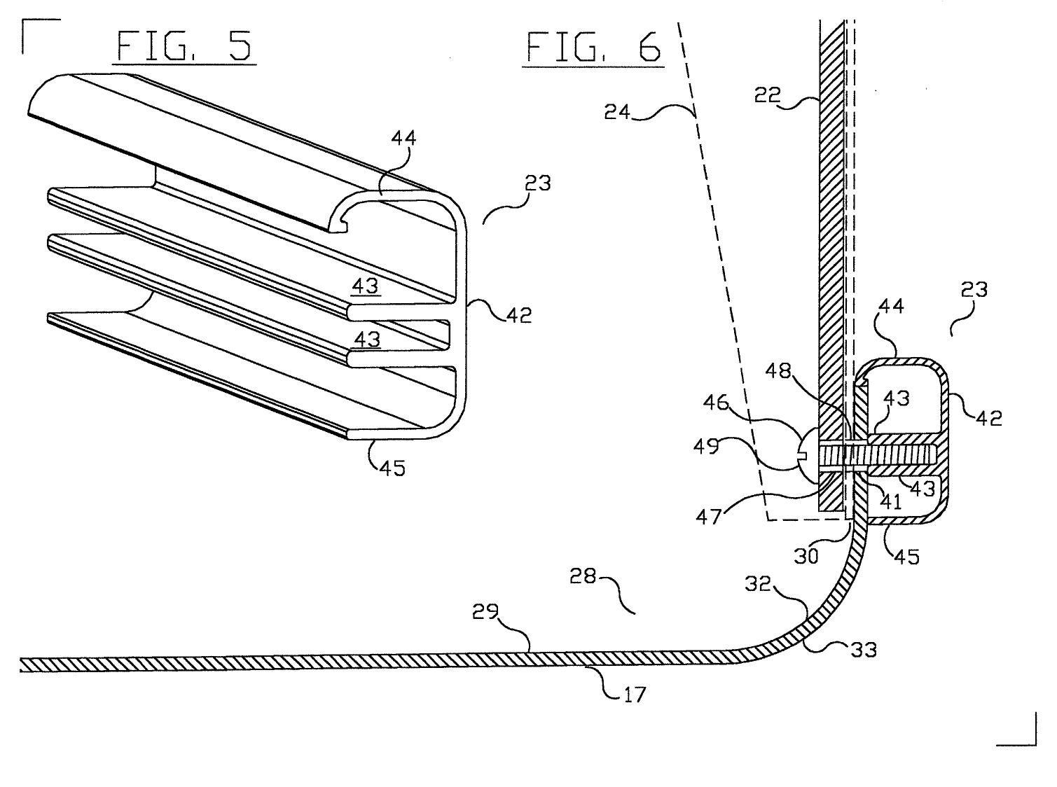

Uniform in cross-section, longitudinal rail member 23 as shown in FIGS. 5 and 6 incorporates a generally vertical longitudinal leg 42, at least two opposing parallel spaced outboard extending longitudinal legs 43, an upper horizontal outboard extending longitudinal leg 44 and a lower horizontal outboard extending longitudinal leg 45. Threaded fasteners 46 with threaded portion outside diameter larger than vertical distance in between opposing parallel outboard extending longitudinal legs 43, attach overhead parcel rack panels 17 to longitudinal rail member 23 by passing through holes 38 and inboard vertical surface 30 of overhead parcel rack sections 17 and self thread into two opposing parallel longitudinal legs 43 of longitudinal rail member 23. Similarly, vertically extending hanger brackets 22 are conveniently spaced anywhere along horizontally extending rail member 23 and attached with threaded fasteners 46 into outboard extending longitudinal legs 43 of rail member 23 after threaded fastener 46 passes through hole 47 in lower portion of hanger bracket 22, hole 48 in lower portion of hanger bracket 22, hole 48 in lower portion of hanger cover 24 and hole 41 in inboard vertical surface 30 of overhead parcel rack 17, thereby sandwiching and firmly attaching hanger 22, hanger cover 24 and overhead parcel rack section 17 between head 49 of fastener 46 and rail member 23.

As can be seen in FIGS. 1, 2, and 7, threaded or non-threaded fasteners 50 (not shown), passing through holes 53 in upper outboard extending horizontal surface 51 of hanger bracket 22 and holes 55 in upper matching surface of hanger cover 24, attach hanger bracket 22 and hanger cover 24, by sandwiching onto roof structure 56 (not shown) behind ceiling 15 of mass transportation vehicle 14. Thermoformed or injection molded endcaps 63 (not shown) enclose and cap longitudinal forwardmost, rearmost and in-between interruption and termination locations of overhead parcel rack 10.

In another embodiment of this invention as shown in FIG. 7, composite panel 64 is formed to create a vertical surface 58, a horizontal bottom surface 57, an upper horizontal mounting flange 59 and a lower outboard vertical mounting surface 63. Bending of composite panel 64 is performed ensuring bend radius 60 to be minimally exceeding that radius at which yield strength of composite material 64 outer skin 61 will be exceeded and thereby causing outer skin 61 fracture.

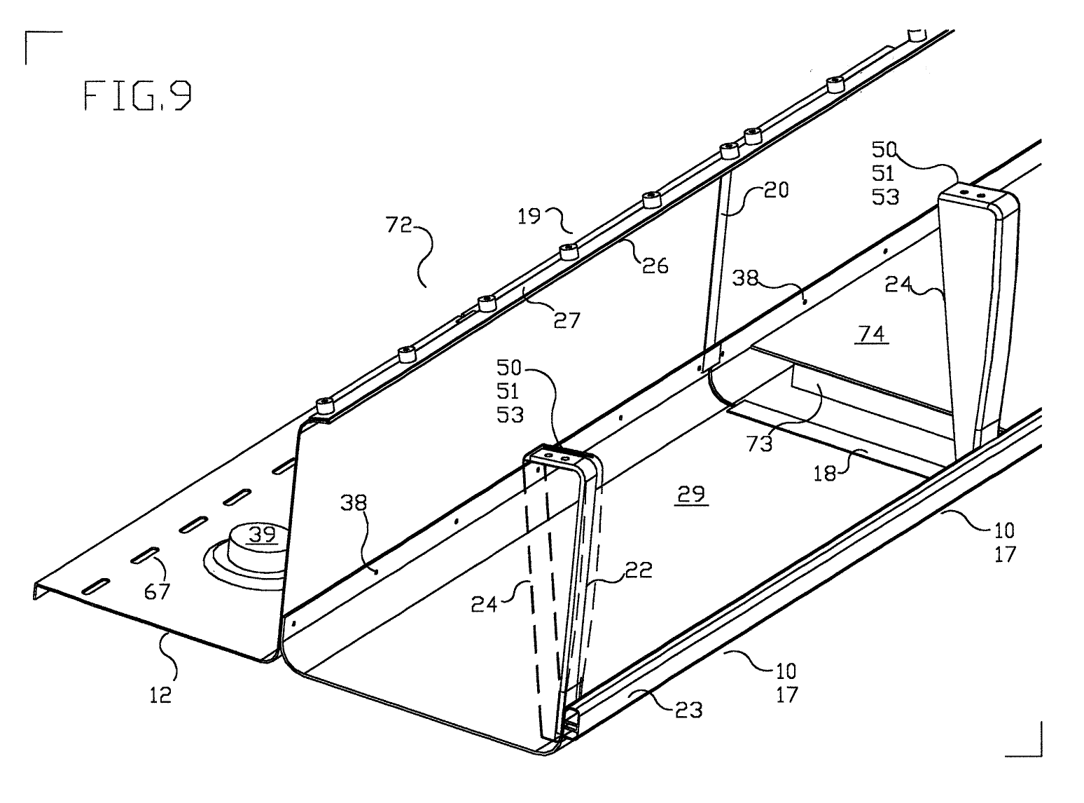

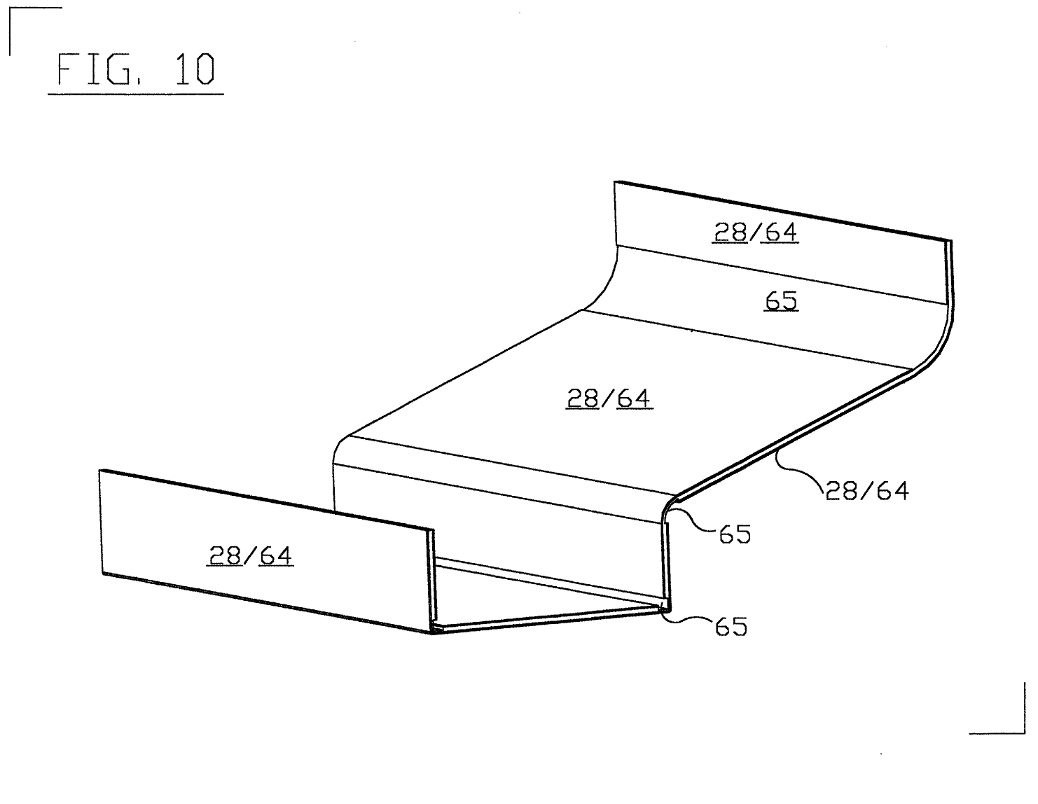

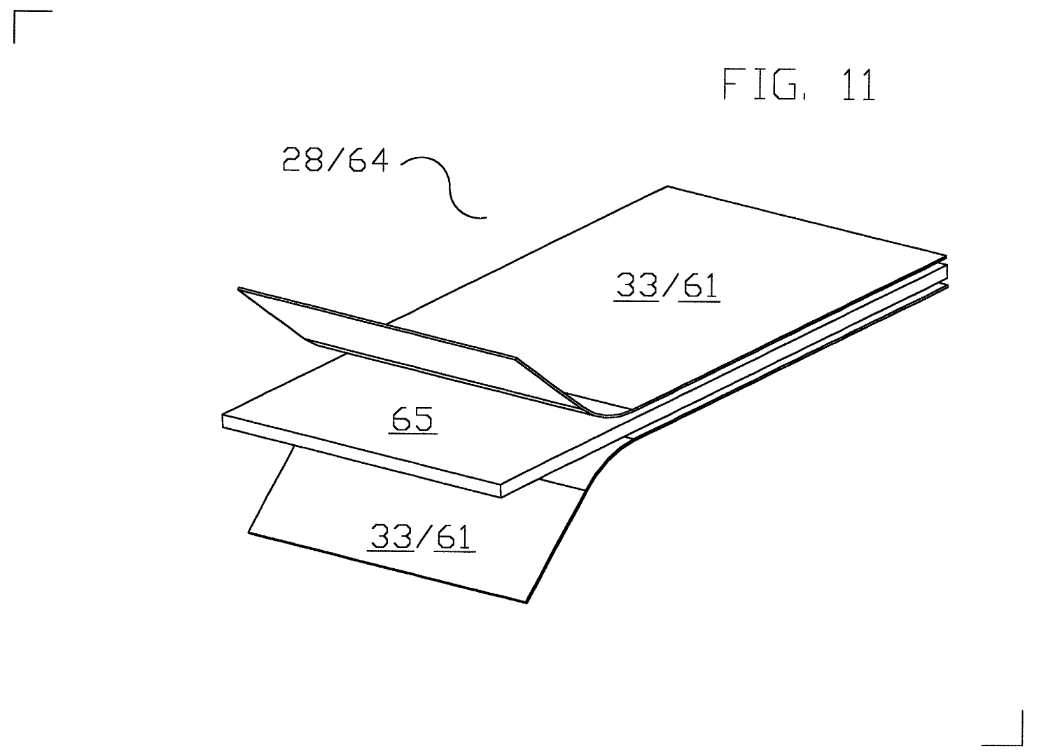

Another preferred method of bending composite panel 64 and 28 (FIGS. 1, 2, 3, 6, 7 and 9) is illustrated in FIGS. 7 and 9 where lower vertical flange 63 is created by bending, after which a longitudinally narrow portion of one outer skin 61 of composite panel 64 as well as a corresponding portion of plastic core material 64 is removed and the composite panel sections 64 adjacent to skin and core removal are folded into the desired angle. Many possible variations of this method of scoring and forming of composite panel 28 and 64 according to this invention as shown in FIG. 10 are possible, including, but not limited to removing of different widths of one outer skin of composite panel 28 and 64 only and removing of different widths of outer skin and differing amounts of inner core material.

In further reference to FIG. 7, lower vertical mounting surface 63 is provided with mounting holes 66 allowing for the attachment with fasteners (not shown) of modular sections of HVAC duct 19 to sidewall 16 of mass transportation vehicle 14. In similar fashion HVAC duct upper horizontal flange 59 is attached to ceiling 15 of mass transportation vehicle 14, thereby attaching modular HVAC duct 19 to vehicle 14 and creating the functional HVAC duct. Elongated outlet slots 67 or commonly known outlet registers or louvers are provided and conveniently spaced along the bottom horizontal surface 57 and inboard vertical surface 58 providing desired or even distribution of conditioned air to the inside of mass transportation vehicle 14. Similarly, reading lights 40, speakers 39 and other convenience items are provided and conveniently spaced along the bottom horizontal surface 57 of HVAC duct 19.

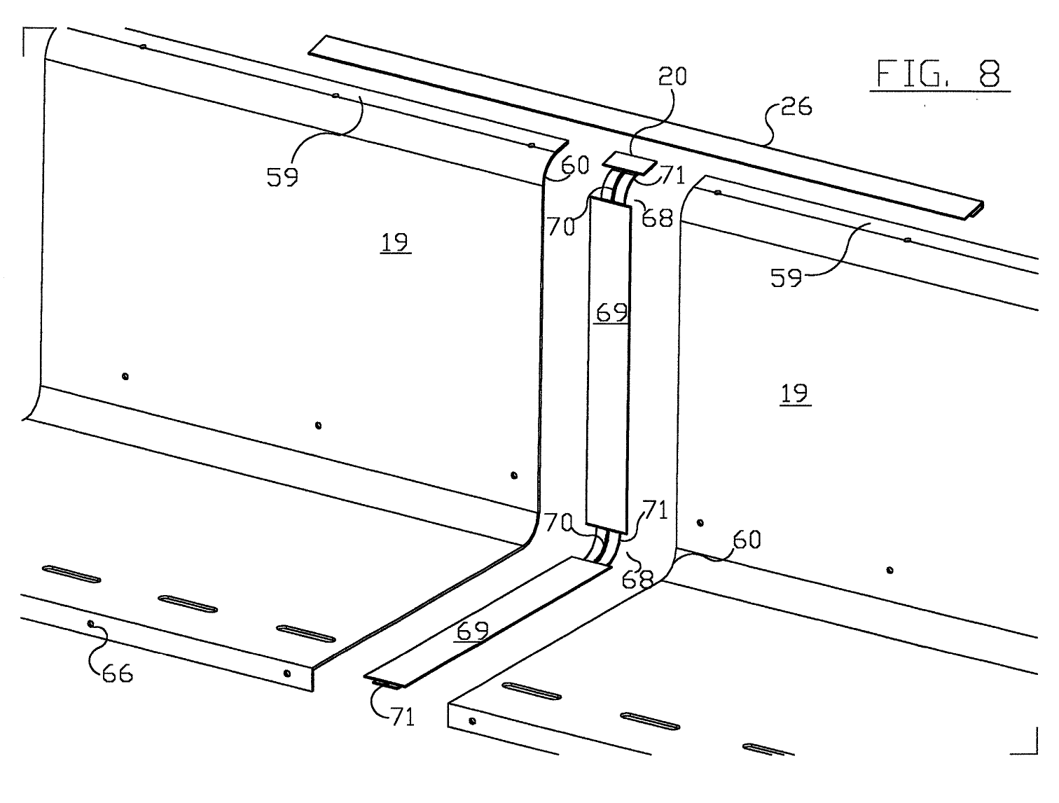

As can be seen in FIGS. 7 and 8, modular longitudinal sections of HVAC ducts 19 are connected end to end by means of uniform in cross-section longitudinally extruded plastic dividers 20 resembling unequal in length “H” shape. Dividers 20 are notched 68 to easily conform to formed shape and bend radius 60 of adjoining modular HVAC duct sections 19. Notching 68 is accomplished by removing a portion of inside leg 69 of divider 20 approximately equal in length to arc length of modular HVAC duct section 19 inside bend radius, leaving part of connecting short leg 70 and all of outer leg 71 of HVAC duct divider 20 in notch area 68 thereby facilitating the ease of shaping divider 20 to conform with bend radius, arc and angle in HVAC duct 19 during installation. HVAC duct divider 20 is preferably of unequal length “H” cross-sectional shape, further easing end to end assembly of HVAC duct sections 19.

Thermoformed injection molded endcap 62 (not shown) enclose and cap longitudinal forwardmost, rearmost and in-between interruption and terminations of HVAC duct 19.

In yet another embodiment of this invention, as shown in FIG. 9, modular sections of overhead parcel rack 17 are endwise attached together with overhead parcel rack dividers 18, attached to longitudinal rail member 23 with hangers 22 and hanger covers 24 and attached to modular sections of HVAC duct 19 attached together forming a combination overhead parcel rack and HVAC duct 72. Furthermore, spacers 73 are provided atop duct upper horizontal flange 59 providing when installed, outlet slots between HVAC duct upper horizontal flange 59 and vehicle ceiling 15. Spacers 73 are provided at convenient intervals on top of overhead parcel rack horizontal bottom surface 29 providing support for longitudinally extending flat overhead parcel rack false floor 74 which combined allows convenient space for installation of speakers 39 and reading lights 40 through and onto bottom of overhead parcel rack horizontal bottom surface.

In further explanation regarding forming and bending of composite panels 28 and 64 without the removal of outer skin material 33 and inner core material 65 as it applies to this invention it is necessary to realize that in definition for this invention: the minimum bend radii to which any given composite panel can effectively be bent which will minimally exceed the yield strength of given composite panel prior to causing outer skin fracture is amongst others, more a direct function of both total overall thickness of composite panel and thickness of composite panel outer skin.

Referring to FIG. 11, composite material panel 28 and 64 as used and described in the implementation of this invention, consists of mainly inner core material 65 selected from plastics material group laminated on one or both side surfaces with skin material 33 and 61 selected from metals materials group including aluminum and steel.

It is to be understood that present invention is not limited to the embodiments described above, but encompasses any and all embodiments within the scope of the following claims.

I claim:

1. An overhead parcel rack for the inside of mass transportation vehicles, comprising:
a substantially rigid and formed panel constituting the inner floor and the outer bottom, inboard vertical wall and opposed outboard vertical wall of the overhead parcel rack,
a longitudinal handrail member attached to said parcel rack,
hanger brackets attached to said longitudinal handrail member,
hanger covers substantially enclosing the visible surfaces of said hanger brackets,
a false floor supported above said inner floor of said overhead parcel rack.

2. An overhead parcel rack as set forth in claim 1 wherein said overhead parcel rack is made from a material selected from the composite materials group consisting of a plastic core with metal skins.

3. An overhead parcel rack according to claims 1 and 2, wherein forming of said composite panel is accomplished by bending to a bending radius minimally exceeding that radius at which yield strength of outer skin of composite panel will be exceeded.

4. An overhead parcel rack according to claims 1 and 2, wherein forming of said composite panel is accomplished by scoring and folding which entails the longitudinal removing a narrow strip of skin and portion of plastic core material and bending of said panel along created score line at radius substantially less than according to claim 3.

5. An overhead parcel rack as set forth in claim 1, wherein said longitudinal handrail member incorporates a U-shaped cross-section portion adapted to receive threaded fasteners attaching said overhead parcel rack panel to said longitudinal handrail member.

6. An overhead parcel rack as set forth in claim 1, wherein said hanger brackets incorporate holes facilitating the attachment of said hanger brackets by means of threaded fasteners into said U-shaped cross-section portion of said longitudinal handrail member as set forth in claim 5.

7. An overhead parcel rack as set forth in claim 1, wherein said hanger covers are made from materials selected from the thermoformed and injection molded plastics group.

8. An overhead parcel rack as set forth in claim 1, wherein said false floor is supported above said inner floor of said overhead parcel rack by means of spacer blocks.

9. A HVAC duct for the inside of mass transportation vehicles, comprising:
a substantially rigid and formed panel forming the horizontal lower and vertical inboard walls of said duct,
a horizontal inboard extending upper mounting flange including a J-trim,
a vertical downward extended mounting flange, air outlet apertures, spacers and mounting surface for reading lights, speakers and televisions.

10. A HVAC duct for the inside of mass transportation vehicles as set forth in claim 9, wherein said duct is made from a material selected from the composite materials group consisting of a plastic core with metal skins.

11. A HVAC duct for the inside of mass transportation vehicles according to claims 9 and 10, wherein forming of said composite panel is accomplished by bending to a bending radius minimally exceeding that radius at which yield strength of outer skin of composite panel will be exceeded.

12. A HVAC duct for the inside of mass transportation vehicles according to claims 9 and 10, wherein forming of said composite panel is accomplished by scoring and folding which entails the longitudinal removing a narrow strip of skin and portion of plastic core material and bending of panel along created score line at radius substantially less than according to claim 3.

13. A HVAC duct for the inside of mass transportation vehicles according to claim 9, wherein said J-rim is constituted by a uniform in cross-section generally or J-shape, longitudinal member of plastic extruded material.

14. A HVAC duct for the inside of mass transportation vehicles according to claim 9, wherein air outlet apertures are provided in the horizontal lower and/or vertical inboard walls of said duct.

15. A HVAC duct for the inside of mass transportation vehicles according to claim 9, wherein said horizontal lower wall of said duct provides mounting surface for reading lights, speakers, television monitors and the like.

16. A HVAC duct for the inside of mass transportation vehicles according to claim 9, wherein spacers are inserted between said horizontal inboard extending upper flange and ceiling of vehicle, thereby creating air outlet apertures.

17. A combined overhead parcel rack and HVAC duct comprising a HVAC duct according to claim 9 with an overhead parcel rack according to claim 1, wherein said overhead parcel rack is attached through said vertical outboard or horizontal wall into said vertical inboard or horizontal lower wall of said HVAC duct.

18. A combined overhead parcel rack and HVAC duct according to claim 17, wherein:
said individual overhead parcel rack sections are connected to longitudinally extended adjacent overhead parcel rack sections by means of uniform in cross-section, longitudinal members of plastic extrusion material resembling H-shape,
said individual HVAC duct panel sections are connected to longitudinally extending adjacent HVAC duct sections by means of uniform in cross-section, longitudinal members of plastic extrusion material resembling H-shape,
one leg surface of said longitudinal, H-shaped plastic material member is partially removed enabling the continuance of said member around said bends in said overhead parcel rack and said HVAC duct panels.

19. A combined overhead parcel rack and HVAC duct according to claim 17, including endcaps terminating the longitudinal ends of said overhead parcel rack and HVAC duct wherein said endcaps are made from materials selected from the thermoformed and injection molded plastics group.

20. A combined overhead parcel rack and HVAC duct according to claim 17, wherein the exposed surfaces of said overhead parcel rack and HVAC duct is covered with materials selected from the fabrics, cloth, carpet or vinyl groups.
